(19) United States
(12) Patent Application Publication
(10) Pub. No.: US 2015/0365254 A1
(43) Pub. Date: Dec. 17, 2015

(54) NETWORK RELAY APPARATUS AND METHOD FOR GENERATING A DATA FORWARDING TABLE

(71) Applicant: ELECTRONICS AND TELECOMMUNICATIONS RESEARCH INSTITUTE, Daejeon (KR)

(72) Inventor: Jee Sook EUN, Daejeon (KR)

(21) Appl. No.: 14/623,027

(22) Filed: Feb. 16, 2015

(30) Foreign Application Priority Data
Jun. 12, 2014 (KR) 10-2014-0071554

(51) Int. Cl. H04L 12/44; H04L 12/741

(52) U.S. Cl. CPC H04L 12/44; H04L 45/745; H04W 84/12

(57) ABSTRACT

A network relay apparatus includes: a neighbor node list generation unit configured to generate a neighbor node list including neighbor nodes adjacent to a source node; a modified spanning tree generation unit configured to select one node from the neighbor node list to generate a path tree; a path searching unit configured to search for a path from a destination node to a source node at the path tree to backtrack whether the node selected from the neighbor node list is present within the searched path; and a data forwarding table generation unit configured to generate a data forwarding table in which the selected node is added to a neighbor node if it is determined based on the backtracking result of the path searching unit that the node selected from the neighbor node list is present within the path.

### CROSS-REFERENCE TO RELATED APPLICATIONS

This application claims priority to and the benefit of Korean Patent Application No 10-2014-0071554 filed in the Korean Intellectual Property Office on Jun. 12, 2014, the entire contents of which are incorporated herein by reference.

### TECHNICAL FIELD

The present invention relates to a network relay apparatus and a method for generating a data forwarding table, and more particularly, to a technology of generating a data forwarding table capable of generating a plurality of routing paths in a network relay apparatus such as a switch, a bridge, and a router.

### BACKGROUND ART

Among the methods for setting a path among several relay apparatuses on a network, a spanning tree protocol (STP) to solve a traffic looping problem that occurs by interconnecting several LANs has been proposed in the IEEE standard 802. ID.

The spanning tree protocol has been used to solve the looping problem which occurs due to a bridge which is mainly used in an enterprise network. However, with the increased demand for a communication market, a connection between a head office and a branch office, a connection between a user and an enterprise, and a connection between enterprises are gradually required. The spanning tree protocol does not satisfy the demand.

That is the spanning tree protocol provides a single path from a source node to a destination node and therefore the loop is not generated; however, when the amount of transmission data is large, it is impossible to implement a network control capable of controlling a load of a network by appropriately distributing an amount of data.

Further, in the case of the router, an equivalent multipath technique which is an algorithm searching for a plurality of paths depending on the routing protocol has been used. The algorithm calculates all the paths which may be calculated in the network and therefore becomes a factor of increasing costs of the router.

### SUMMARY OF THE INVENTION

The present invention has been made in an effort to provide a technology capable of applying a modified spanning tree in a network relay apparatus such as a switch, a bridge, a router, and the like to provide a plurality of paths, thereby reducing calculation costs and complexity of the paths.

An exemplary embodiment of the present invention provides a network relay apparatus, including: a neighbor node list generation unit configured to generate a neighbor node list including neighbor nodes adjacent to a source node; a modified spanning tree generation unit configured to select one node from the neighbor node list to generate a path tree; a path searching unit configured to search for a path from a destination node to a source node at the path tree to backtrack whether the node selected from the neighbor node list is present within the searched path; and a data forwarding table generation unit configured to generate a data forwarding table in which the selected node is added to a neighbor node if it is determined based on the backtracking result of the path searching unit that the node selected from the neighbor node list is present within the path.

The neighbor node list generation unit may delete the selected node from the neighbor node list if it is determined based on the backtracking result of the path searching unit that the node selected from the neighbor node list is not present within the path.

The neighbor node list generation unit may delete the selected node from the neighbor node list when the node selected from the neighbor node list is generated to be included in the data forwarding table.

The modified spanning tree generation unit may delete links toward the rest of the non-selected neighbor nodes other than the node selected from the neighbor node list and then generate a shortest path tree.

The modified spanning tree generation unit may generate the neighbor node list and then determine whether the number of neighbor nodes included in the neighbor node list is at least two.

The modified spanning tree generation unit may select one of the neighbor nodes to generate the shortest path tree when the number of neighbor nodes is at least two.

The network relay apparatus may be at least one of a switch, a bridge, and a router.

Another exemplary embodiment of the present invention provides a method for generating a data forwarding table, including: generating a neighbor node list including neighbor nodes adjacent to a source node; selecting one node from the neighbor node list to generate a path tree; determining whether the selected node is included in a path from the destination node to the source node by backtracking a path from a destination node to the source node at the path tree; and generating the data forwarding table depending on whether the selected node is present in the path from the destination node to the source node.

The generating of the path tree may include: determining whether at least two neighbor nodes are present in the neighbor node list; selecting one neighbor node from the neighbor node list when at least two neighbor nodes are present; and generating a shortest path tree by setting the selected neighbor node to a first node of a temporary node repository.

The generating of the data forwarding table may include adding the selected node to the neighbor node of the data forwarding table when the selected node is present.

The generating of the data forwarding table may further include deleting the selected node from the neighbor node list after the adding of the selected node to the neighbor nodes of the forwarding table.

The generating of the data forwarding table may include deleting the selected node from the neighbor node list when the selected node is not present.

The data forwarding table may include information on the destination node and the neighbor node.

In the generating of the path tree, links toward the rest of the non-selected neighbor nodes other than the node selected from the neighbor node list may be deleted and then a shortest path tree may be generated.

According to the exemplary embodiments of the present invention, it is possible to remarkably reduce the complexity and costs occurring at the time of calculating all the possible paths independent of the costs in the network relay apparatus and additionally provide the number of paths which may be selected at the time of controlling the network load using the plurality of paths, by generating only the same number of trees as the number of neighbor nodes of the source node and tracking the paths of each tree to generate the data forwarding table to the destination node in the network relay apparatus such as the switch, the bridge, and the router.

### BRIEF DESCRIPTION OF THE DRAWINGS

FIG. 1 is a configuration diagram of a network relay apparatus according, to an exemplary embodiment of the present invention.

FIG. 2 is an exemplified diagram of a network configuration.

FIGS. 3A to 3D are exemplified diagrams illustrating setting of a network path using a spanning tree.

FIGS. 4A to 4D are exemplified diagrams illustrating the setting of the network path using a modified spanning tree according to the exemplary embodiment of the present invention.

FIG. 5 is a flow chart illustrating a method for generating a data forwarding table according to an exemplary embodiment of the present invention.

FIG. 6 is a diagram for describing a method for generating a data forwarding table according to an exemplary embodiment of the present invention when a plurality of neighbor nodes is present.

FIGS. 7A to 7D are exemplified diagrams illustrating setting of a network path using a modified spanning tree according to another exemplary embodiment of the present invention.

FIG. 8 is a flow chart illustrating a method for generating a data forwarding table according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings for detailed description so that those skilled in the art may easily implement the spirit of the present invention.

The present invention relates to a technology of imparting efficiency to a network control by providing a method for providing a plurality of paths in a network relay apparatus such as a switch, a bridge, and a router in which multiplex transmission is implemented using a modified spanning tree repeatedly using a spanning tree used in the switch without using an equivalent multipath technique used in the router, thereby reducing calculation costs of the path and reducing complexity of the switch.

That is, the present invention relates to a technology of making a method for calculating a path of routing using an equivalent multipath so as not to provide all the paths but provide only the cheapest equivalent path and supporting a multipath using a spanning tree required less than costs required to provide all the paths, and generates a data forwarding table from a switch to a destination node for generating only the trees having the same number as the number of neighbor nodes of a source node, thereby reducing complexity thereof while providing the multipath.

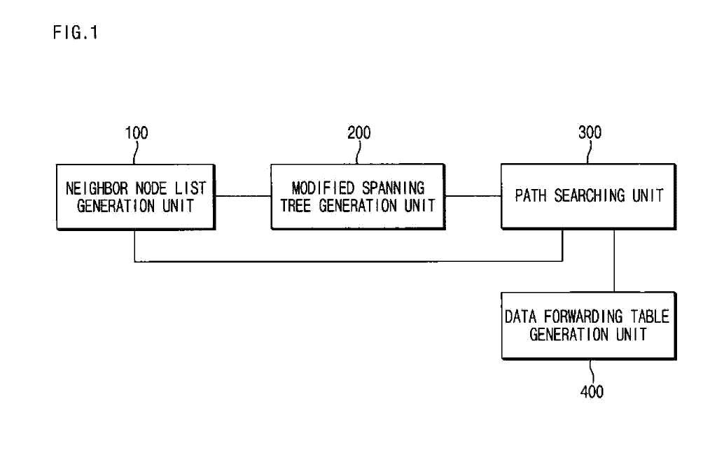

Hereinafter, a network relay apparatus and a method for generating a data forwarding table according to the exemplary embodiment of the present invention will be described with reference to FIGS. 1 to 8.

FIG. 1 is a configuration diagram of a network relay apparatus according to an exemplary embodiment of the present invention.

The network relay apparatus according to the exemplary embodiment of the present invention includes a neighbor node list generation unit 100, a modified spanning tree generation unit 200, a path searching unit 300, and a data forwarding table generation unit 400. In this case, the network relay apparatus may include a switch, a bridge, or a router.

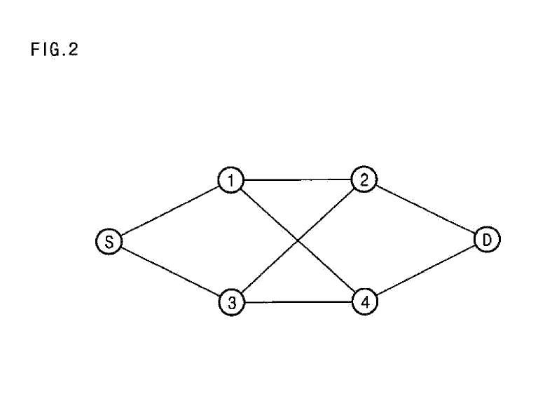

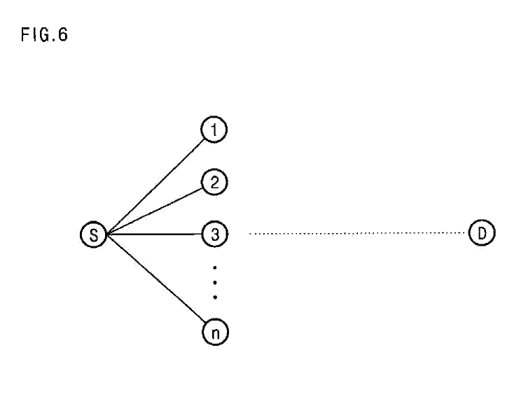

The neighbor node list generation unit 100 generates a list of neighbor nodes adjacent to a source node. In this case, in FIG. 2, as the node adjacent to the source node, a total of two neighbor nodes, i.e., node 1 and node 2 are present and in FIG. 6, as the neighbor node, a total of n neighbor nodes from node 1 to node n are present.

The modified spanning tree generation unit 200 selects any one node from the neighbor node list which is generated from the neighbor node list generation unit 100 and sets the selected one node as node K. Next, the modified spanning tree generation unit 200 selects the node K as a first node of a tent which is a temporary node repository to generate a shortest path tree. Here, the tent means the temporary node repository used at the time of executing a spanning tree algorithm.

The path searching unit 300 searches for a path from node D which is the destination node to node S which is the source node at the shortest path tree generated from the modified spanning tree generation unit 200 to backtrack whether the node K is present on the corresponding path. If it is determined that the node K is not present on the path, the path searching unit 300 requests a deletion of the node K from the neighbor node list of the neighbor node list generation unit 100. Meanwhile, if it is determined that the node K is present on the path, the path searching unit 300 requests an addition of the node K to the data forwarding table of the data forwarding table generation unit 400.

The data forwarding table generation unit 400 includes the neighbor node adjacent to the node D which is the destination node and the node S which is the source node. The data forwarding table for calculating the path from the source node to the destination node of FIG. 2 is as the following Table 1.

TABLE 1

| Destination node | Next hop |
|---|---|
| D | 1 |
| D | 3 |

FIG. 2 is an exemplified diagram of a network configuration.

In the case of searching for the path from the node S to the node D in a network configured of a total of six nodes S, 1, 2, 3, 4, and D, when all the costs of the respective nodes are the same, it is possible to search for a total of four paths based on an equivalent multipath technique.

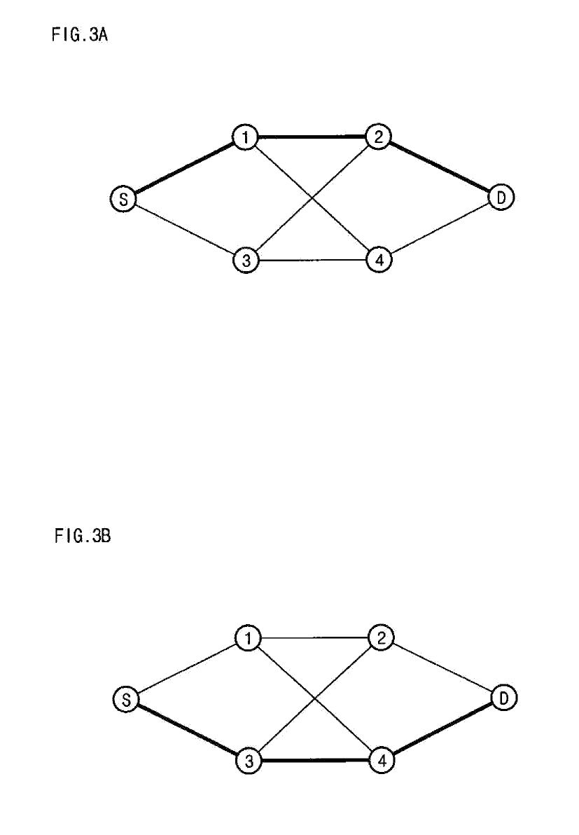

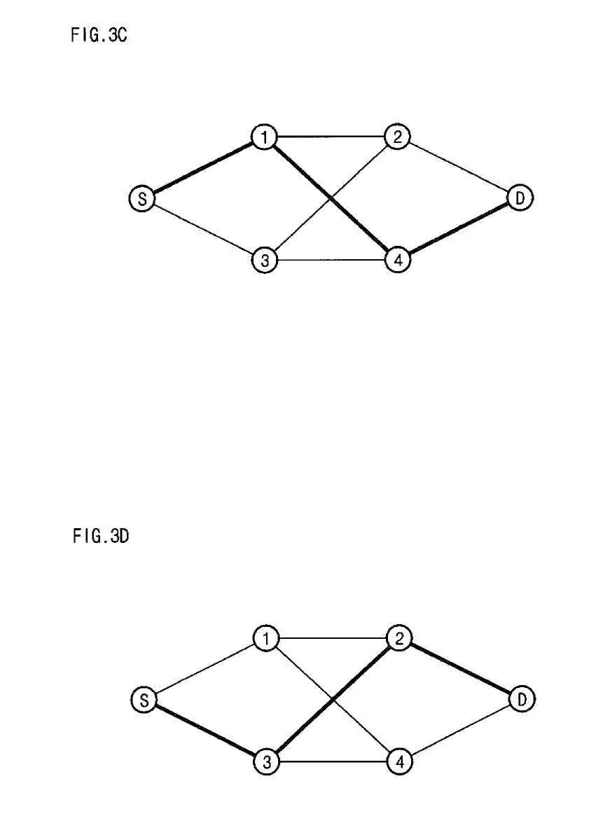

FIGS. 3A to 3D are exemplified diagrams of a network path which may be searched using an equivalent multipath.

Four paths illustrated in FIGS. 3A to 3D may be acquired by setting the network path using the equivalent multipath. That is, FIG. 3A illustrates an example in which the path is set in order of node S→node 1→node 2→node D, FIG. 3B illustrates an example in which the path is set in order of node S→node 3→node 4→node D, FIG. 3C illustrates an example in which the path is set in order of node S→node 1→node 4→node D, and FIG. 3D illustrates an example in which the path is set in order of node S→node 3→node 2→node D. However, when using the equivalent multipath, only the cheapest one of the paths is obtained in the case in which costs of the respective nodes are not the same. Further, the equivalent path is calculated by a modification of Dijkstra algorithm and therefore the unnecessary path search needs to be performed.

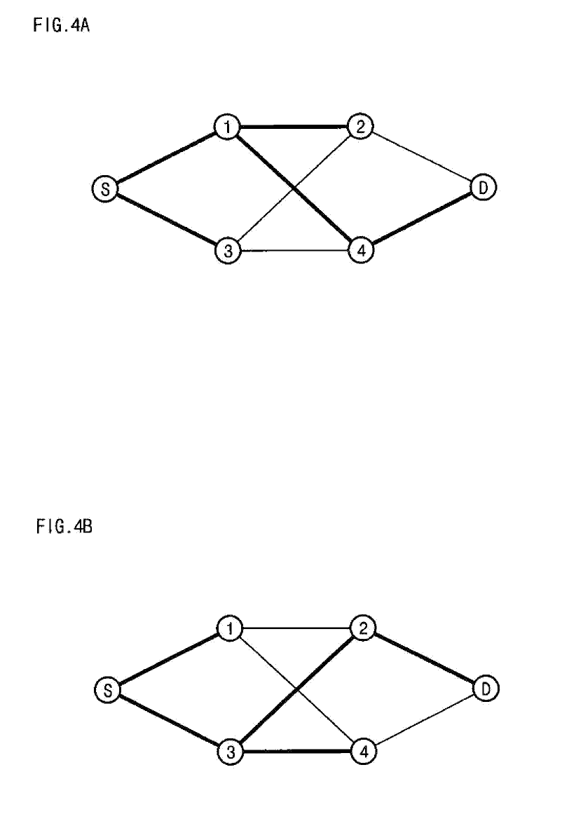

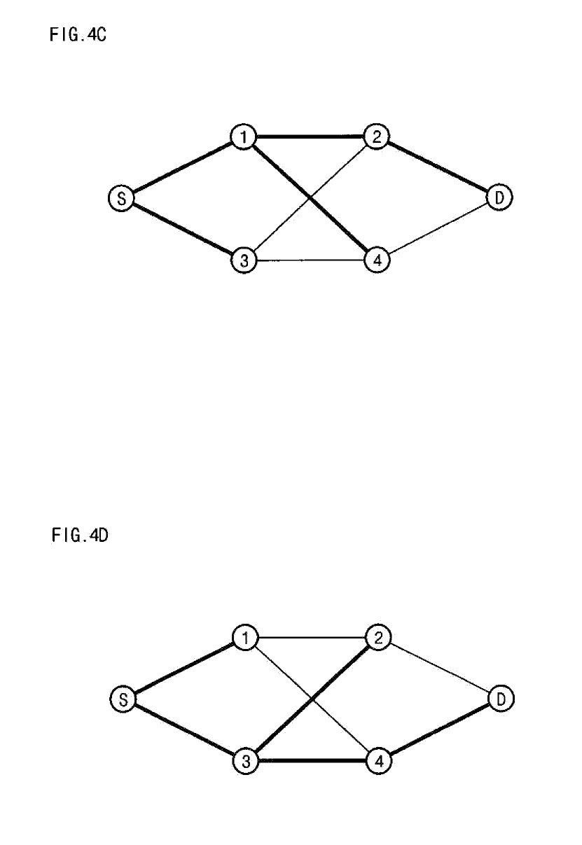

FIGS. 4A to 4D are exemplified diagrams illustrating the setting of the network path using a modified spanning tree according to the exemplary embodiment of the present invention.

The modified spanning tree technique according to the exemplary embodiment of the present invention changes a portion searching for a neighbor using the spanning tree technique to acquire a plurality of spanning trees That is, when configuring the tree, the modified spanning tree is generated depending on a discovery order of the neighbor nodes.

In the case of FIG. 4A, the node S processes the node 1 and the node 3 which are neighbor nodes, processes the node 2 and the node 4 which are neighbor nodes of the node 1, and processes the node D which is a neighbor node of the node 4. In this case, the neighbor node of the node 1 is not processed in order of the node 2 and the node 4 but processed in order of the node 4 and the node 2 and then the node D which is the neighbor node of the node 2 is processed, thereby configuring the tree form of FIG. 4C. Meanwhile, FIG. 4C illustrates the case in which the node S processes the node 3 and the node 1 which are neighbor nodes, processes the node 4 and the node 2 which are neighbor nodes of the node 3, and processes the node D which is a neighbor node of the node 2. FIG. 4D illustrates the case in which the neighbor nodes of the node 3 are processed in order of the node 2 and the node 4 and then the node D which is a neighbor node of the node 4 is processed.

The order of processing the neighbor of the node S which is a root is changed by the above method to be able to confirm whether the path to the node D which is the destination is present through the corresponding neighbor. FIGS. 4A and 4C illustrate the tree forms in the case in which node 1, which is the neighbor node of the node S is first processed, and it may be confirmed that the path to the node D is present through the node 1.

Meanwhile, when the node 3, which is the neighbor node is first processed, the tree forms of FIGS. 4B and 4D are obtained, thereby confirming that the path to the node D is present through the node 3. Further, the total number of generated trees is four, but it may be appreciated that the number of the routing paths to the node D obtained at the node S is two and relies on the number of neighbors adjacent to the node S.

Therefore, the present invention does not calculate all the spanning trees to search for the path from the node S to the node D but calculates the spanning tree by changing the processing order of the neighbor of the node S to acquire the spanning trees corresponding to the number of neighbors of the node S, searches for the path of each tree to confirm whether the node D is present, and then generates the data forwarding table.

Next, the data forwarding table is corrected by determining whether the neighbor node is present by backtracking the path from the destination node to the source node and a process of correcting the data forwarding table is as, follows.

According to the present invention, in FIG. 2, the node 1 which is the neighbor node of the node S is first processed, the trees of FIGS. 4A and 4C are acquired, and then, the path of the node D is backtracked to confirm the path. That is, if it is assumed that the node 4a is acquired, the back path from the node S to the node D becomes node D→node 4→node 1→node S and since the node 1 is present on the path, the node 1 becomes the neighbor node at which the path to the node D is present.

In FIG. 2, the node 3 which is the neighbor node of the node S is first processed to acquire the tree of FIG. 4B or 4D and then the path of the node D is back tracked to confirm whether the path is present. In the case of the node 4b, the back path from the node S to the node D becomes node D→node 2→node 3→node S and since the node 3 is present on the path, the node 3 becomes the neighbor node at which the path to the node D is present. Based on this, the data forwarding table as illustrated in the above Table 1 which provides the plurality of paths to the single destination may be generated.

As such, the exemplary embodiment of the present invention is a technology of imparting efficiency to a network control by providing a method for providing a plurality of paths having the same costs in the network relay apparatus such as the switch, the bridge, and the router and generates the data forwarding table from the switch to the destination node for generating only the trees having the same number as the number of neighbor nodes of the source node, thereby reducing the complexity thereof while providing the multipath.

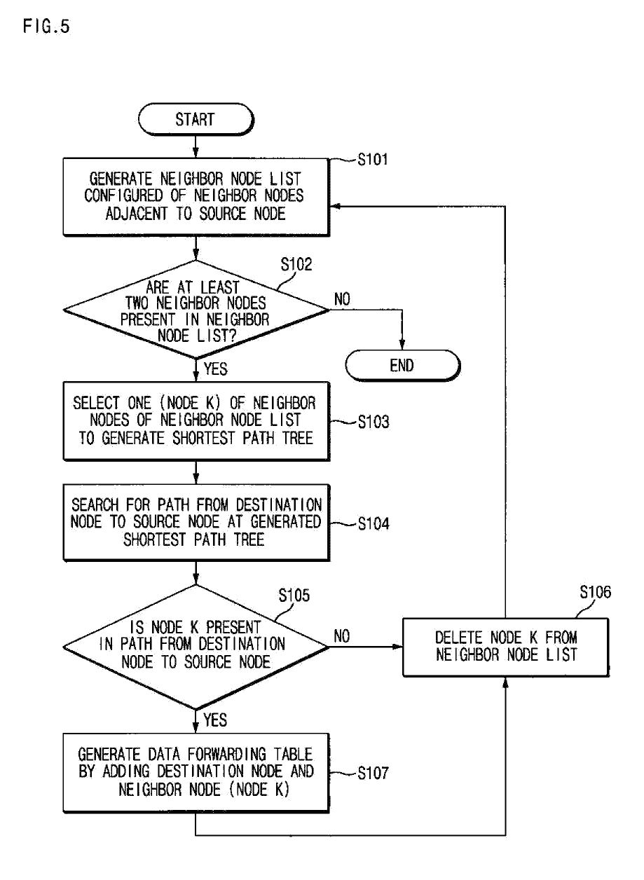

Hereinafter, the method for generating a data forwarding table according to the exemplary embodiment of the present invention will be described with reference to FIG. 5.

First, the neighbor node list generation unit 100 generates the neighbor node list configured of the neighbor nodes adjacent to the source node (S101). As illustrated in FIG. 6, when the neighbor nodes are plural, the number of neighbor nodes is 1 to N.

Next, the modified spanning tree generation unit 200 determines whether at least two neighbor nodes are present in the neighbor node list generated in the neighbor node list generation unit 100 (S102).

When at least two neighbor nodes are not present in the neighbor node list, the neighbor node list includes a single neighbor node and thus there is no need to generate the data forwarding table for setting the multipath according to the present invention, such that the algorithm ends.

Meanwhile, when at least two neighbor nodes are present in the neighbor node list, the modified spanning tree generation unit 200 selects one (node K) of the plurality of neighbor nodes to generate the shortest path tree (S103). That is, the modified spanning tree generation unit 200 selects one of the neighbor nodes included in the neighbor node list and sets the selected node to the node K and then selects the node K as the first node of the tent which is the temporary node repository to generate the shortest path tree. Here, the tent means the temporary node repository used at the time of executing the spanning tree algorithm.

Next, the path searching unit 300 searches for the destination node at the generated shortest path tree and then searches for the path from the destination node to the source node (S104).

Next, the path searching unit 300 determines whether the node K is included in the path from the destination node to the source node (S105) and when the node K is not included in the path from the destination node to the source node, requests the deletion of the node K from the neighbor node list of the neighbor node list generation unit 100. Therefore, the neighbor node list generation unit 100 deletes the node K from the neighbor node list (S106).

Meanwhile, as the determination result of the process S105, when the node K is included in the path from the destination node to the source node, the path searching unit 300 requests the data forwarding table generation unit 400 to include the node K in the path. Therefore, the data forwarding table generation unit 400 adds the node K as the neighbor node of the destination node of the data forwarding table (S107).

As such, when the node K is added to the data forwarding table as the neighbor node, the neighbor node list generation unit 100 deletes the node K from the neighbor node list (S106).

Next, the processes S102 to S107 are repeatedly performed by selecting other nodes other than the node K from the neighbor node list.

FIG. 6 is a diagram for describing a method for generating a data forwarding table according to an exemplary embodiment of the present invention when a plurality of neighbor nodes is present.

In FIG. 6, the case in which the number of neighbor nodes of the source node S is n is disclosed. As illustrated in FIG. 4, in the case in which the number of neighbor nodes of the source node S is plural, when the path is calculated by the equivalent multipath technique, there is a need to calculate the paths of all the other nodes connected to the neighbor nodes. However, when the method for generating a data forwarding table according to the present invention is applied, only the paths corresponding to the number of neighbor nodes of the source node S are calculated and therefore the calculation costs thereof may be remarkably reduced.

As such, the present invention is to calculate the multipath in the network relay apparatus such as the switch, the bridge, and the router and generates only the trees having the same number as the number of neighbor nodes of the source node and tracks the paths of each tree to generate the data forwarding table to the destination node, thereby controlling the network load using the plurality of paths while further reducing the complexity and costs of the path calculation than the method for calculating a path of a router calculating all the paths which may be configured in the network.

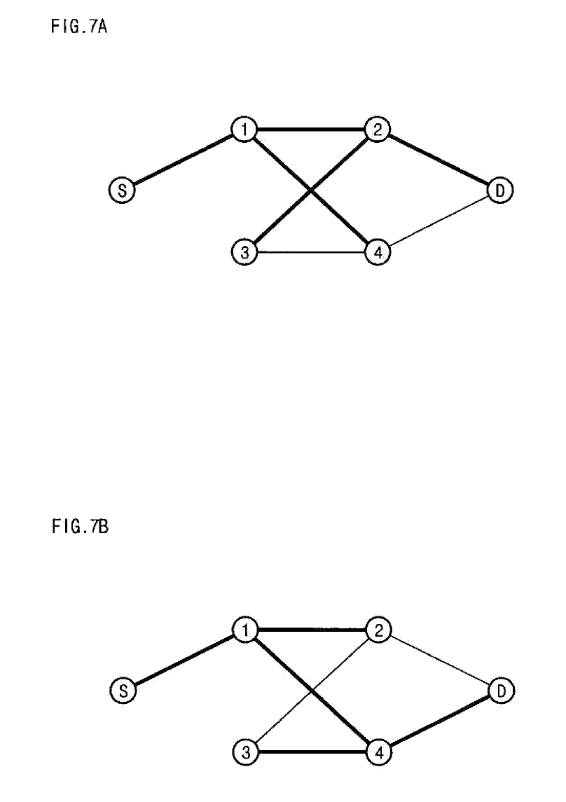

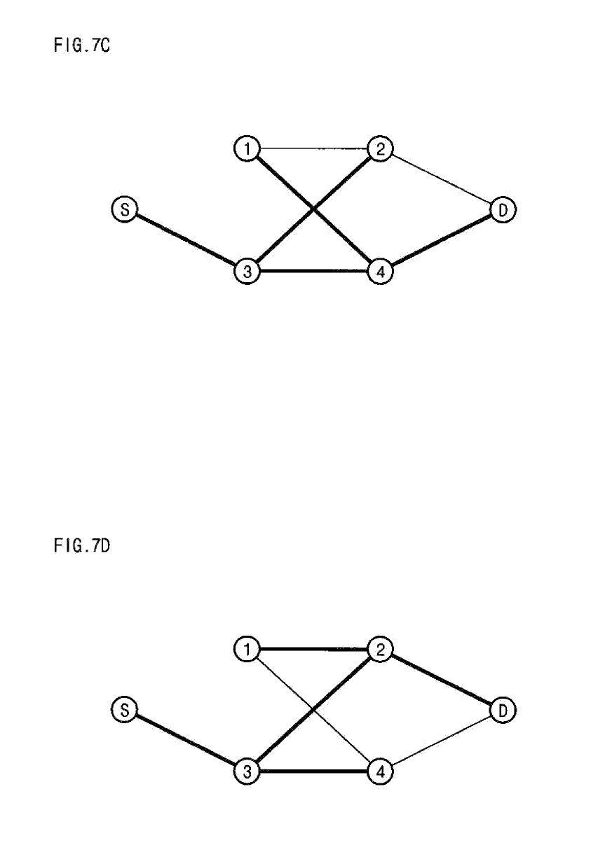

Hereinafter, the example of setting a network path using a modified spanning tree according to another exemplary embodiment of the present invention will be described with reference to FIGS. 7A to 7D.

Referring first to FIG. 7A, the node S processes the node 1 which is the neighbor node, processes the node 2 and the node 4 which are the neighbor nodes of the node 1, and processes the node 3 and the node D which are the neighbor nodes of the node 2.

Referring first to FIG. 7B, the node S processes the node 1 which is the neighbor node, processes the node 2 and the node 4 which are the neighbor nodes of the node 1, and processes the node 3 and the node D which are the neighbor nodes of the node 4.

Referring first to FIG. 7C, the node S processes the node 3 which is the neighbor node, processes the node 2 and the node 4 which are the neighbor nodes of the node 3, and processes the node 1 and the node D which are the neighbor nodes of the node 4.

Referring first to FIG. 7D, the node S processes the node 3 which is the neighbor node, processes the node 2 and the node 4 which are the neighbor nodes of the node 3, and processes the node 1 and the node D which are the neighbor nodes of the node 2.

As such, according to another exemplary embodiment of the present invention, a graph is illustrated as a structure without a loop from the source node toward the rest of the other neighbor nodes by selecting one of the plurality of neighbor nodes of the source node S and including the selected neighbor node and applying the algorithm in the state in which links toward the rest of the neighbors are deleted. Therefore, one destination node is selected and thus the data forwarding table may be generated using the destination node as the example.

Further, another exemplary embodiment of the present invention discloses an example in which the destination node is limited to one but all the nodes may be applied as the destination node. Therefore, as in the exemplary embodiment of the present invention, another exemplary embodiment of the present invention does not provide only one path having minimum cost and searches for all the paths, and informs cost of each path to make the user confirm cost for each path and select the desired path among the paths.

Therefore, compared to the exemplary embodiment of the present invention, another exemplary embodiment of the present invention may further reduce the [symbol] calculation costs.

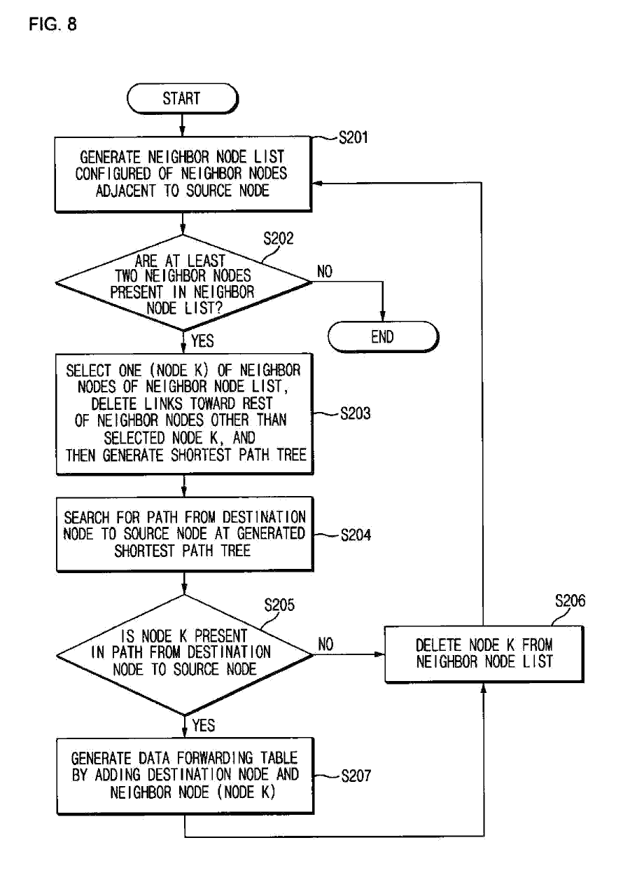

Hereinafter, the method for generating a data forwarding table according to another exemplary embodiment of the present invention will be described with reference to FIG. 8.

Processes S201 and S202 according to another exemplary embodiment of the present invention of FIG. 8 are the same as the processes S101 and S102 according to the exemplary embodiment of the present invention of FIG. 5 and processes 5204 to S207 of FIG. 8 are the same as the processes S104 to S107 of FIG. 5.

However, in the process 5203, according to another exemplary embodiment of the present invention, the modified spanning tree generation unit 200 selects the node K from the neighbor node list and then deletes the links toward the rest of the neighbor nodes other than the node K, thereby generating the shortest path tree. That is, referring to FIG. 7A, when a neighbor node 1 is selected at the source node S, a graph in which a link toward a neighbor node 3 which is not selected is deleted is configured and then the shortest path tree from the source node S toward the destination node D is generated.

As such, according to another exemplary embodiment of the present invention, the Dijkstra algorithm is applied to a graph in which only one of the neighbor nodes of the source node S is selected and included, and the links toward the rest of the neighbor nodes are deleted to generate a graph in which a loop from the source node to the rest of the other neighbor nodes is not present. In this case, one destination node is selected and thus the data forwarding table may be generated using the selected destination node as the example.

Therefore, according to another exemplary embodiment of the present invention, all the multipaths are generated for each neighbor node and cost for each path is provided to the user to enable the user to select the shortest path in consideration of costs.

In this case, the data forwarding table may also be implemented as an example in which all the data forwarding tables are configured at a time and may be implemented as an example in which only several paths configure the data forwarding table without needing all the paths. As a method for configuring all the data forwarding table at a time, there is a method for adding to the table all the rest of the nodes other than the source node S which are present in the graph without needing to select the destination node D.

The exemplary embodiments of the present invention described above have been provided for illustrative purposes. Therefore, those skilled in the art will appreciate that various modifications, alterations substitutions, and additions are possible without departing from the scope and spirit of the invention as disclosed in the accompanying claims and such modifications, alterations, substitutions, and additions fall within the scope of the present invention.

What is claimed is:

1. A network relay apparatus, comprising:
a neighbor node list generation unit configured to generate a neighbor node list including neighbor nodes adjacent to a source node;
a modified spanning tree generation unit configured to select one node from the neighbor node list to generate a path tree;
a path searching unit configured to search for a path from a destination node to a source node at the path tree to backtrack whether the node selected from the neighbor node list is present within the searched path; and
a data forwarding table generation unit configured to generate a data forwarding table in which the selected node is added to a neighbor node if it is determined based on the backtracking result of the path searching unit that the node selected from the neighbor node list is present within the path.

2. The apparatus of claim 1, wherein the neighbor node list generation unit deletes the selected node from the neighbor node list if it is determined based on the backtracking result of the path searching unit that the node selected from the neighbor node list is not present within the path.

3. The apparatus of claim 1, wherein the neighbor node list generation unit deletes the selected node from the neighbor node list when the node selected from the neighbor node list is generated to be included in the data forwarding table.

4. The apparatus of claim 1, wherein the modified spanning tree generation unit deletes links toward the rest of the non-selected neighbor nodes other than the node selected from the neighbor node list and then generates a shortest path tree.

5. The apparatus of claim 1, wherein the modified spanning tree generation unit generates the neighbor node list and then determines whether the number of neighbor nodes included in the neighbor node list is at least two.

6. The apparatus of claim 5, wherein the modified spanning tree generation unit selects one of the neighbor nodes to generate the shortest path tree when the number of neighbor nodes is at least two.

7. The apparatus of claim 1, wherein the network relay apparatus is at least one of a switch, a bridge, and a router.

8. A method for generating a data forwarding table, comprising:
generating a neighbor node list including neighbor nodes adjacent to a source node;
selecting one node from the neighbor node list to generate a path tree;
determining whether the selected node is included in a path from the destination node to the source node by backtracking a path from a destination node to the source node at the path tree; and
generating a data forwarding table depending on whether the selected node is present in the path from the destination node to the source node.

9. The method of claim 8, wherein the generating of the path tree includes:
determining whether at least two neighbor nodes are present in the neighbor node list;
selecting one neighbor node from the neighbor node list when at least two neighbor nodes are present; and
generating a shortest path tree by setting the selected neighbor node to a first node of a temporary node repository.

10. The method of claim 8, wherein the generating of the data forwarding table includes adding the selected node to the neighbor node of the data forwarding table when the selected node is present.

11. The method of claim 10, wherein the generating of the data forwarding table further includes deleting the selected node from the neighbor node list after the adding of the selected node to the neighbor nodes of the data forwarding table.

12. The method of claim 8, wherein the generating of the data forwarding table includes deleting the selected node from the neighbor node list when the selected node is not present.

13. The method of claim 8, wherein the data forwarding table includes information on the destination node and the neighbor node.

14. The method of claim 8, wherein in the generating of the path tree, links toward the rest of the non-selected neighbor nodes other than the node selected from the neighbor node list are deleted and then a shortest path tree is generated.
